(19) United States
(12) Patent Application Publication
(10) Pub. No.: US 2019/0309633 A1
(43) Pub. Date: Oct. 10, 2019

(54) COOLANT CHANNEL WITH INTERLACED RIBS

(71) Applicant: ROLLS-ROYCE plc, London (GB)

(72) Inventor: Martin MOTTRAM, Bristol (GB)

(73) Assignee: ROLLS-ROYCE plc, London (GB)

(21) Appl. No.: 16/355,920

(22) Filed: Mar. 18, 2019

(30) Foreign Application Priority Data
Apr. 9, 2018 (GB) 1805853.7

(51) Int. Cl. F01D 5/18; F01D 25/12

(52) U.S. Cl. CPC F01D 5/187; F05D 2260/22141; F01D 25/12

(57) ABSTRACT

A component for a gas turbine engine, comprising: first and second walls; a coolant channel defined by the space between the first and second walls; and a plurality of ribs extending between the first and second walls, subdividing the coolant channel and configured such that the spaces between the ribs define the direction of flow of coolant through the coolant channel; wherein the ribs are arranged in first and second groups; and the second group of ribs is arranged downstream of the first group of ribs in the direction of the flow of coolant such that the ribs of the second group are aligned with the spaces between the ribs of the first group.

### CROSS REFERENCE TO RELATED APPLICATIONS

This application is based upon and claims the benefit of priority from UK Patent Application No. GB 1805853.7, filed on 9 Apr. 2018, the entire contents of which are which is herein incorporated by reference.

### BACKGROUND

### Technical Field

The present disclosure relates to the provision of components within a gas turbine engine having an internally formed coolant channel. For example, it has been known to provide coolant channels between an inner wall and an outer wall on a suction side of an aerofoil blade or vane that is part of a turbine within such a gas turbine engine.

### Description of the Related Art

In order to make such components, it has been known to use an investment casting process using a ceramic core to form the internal cooling channel. In such an arrangement, a ceramic core is formed that has the shape of the desired internal cooling passages. The component is then formed around the ceramic core, which is subsequently removed, e.g. leached with alkaline solution to leave the hollow metal component.

It has also been known to provide ribs between the inner and outer walls. These ribs may attach the inner and outer walls together, improving the structural strength, and may be used to direct the flow of coolant through the coolant channel that is defined by the inner and outer wall. However, the ribs in the final product are holes within the ceramic core used to form the final product. These holes, may reduce the strength of the ceramic core, leading to breakage during the casting process.

It may therefore be desirable to provide an improvement to this system.

### SUMMARY

According to a first aspect there is provided an aerofoil blade or vane for a gas turbine engine, comprising an aerofoil leading edge, an aerofoil trailing edge an aerofoil suction side having a crown point; first and second walls provided on the aerofoil suction side; a coolant channel for cooling the aerofoil suction side defined by the space between the first and second walls; and a plurality of ribs extending between the first and second walls, subdividing the coolant channel and configured such that the spaces between the ribs define the direction of flow of coolant through the coolant channel; wherein the ribs are arranged in first and second groups; and the second group of ribs is arranged downstream of the first group of ribs in the direction of the flow of coolant such that the ribs of the second group are aligned with the spaces between the ribs of the first group; wherein the distance from the crown point of the aerofoil to the midpoint between the first and second group of ribs is less than 8% of the suction side length of the aerofoil from the crown point to the aerofoil trailing edge.

In an arrangement, a part of at least one rib in the second group of ribs extends into the space between two ribs in the first group with which it is aligned.

The length of the part of the at least one rib in the second group that extends into the space between two ribs in the first group may be less than 5 mm, optionally less than 3 mm. In an arrangement, at least one rib in the second group is configured such that no part of the rib extends into the space between the two ribs in the first group with which it is aligned.

The end of the at least one rib in the second group may be separated from the ends of the two ribs in the first group by a distance in the direction of the flow of the coolant of less than 5 mm, optionally less than 3 mm.

In an arrangement, the coolant channel may increases in cross-section in the direction of flow of coolant; and the number of ribs in the second group is greater than the number of ribs in the first group.

In an arrangement, the coolant channel may decreases in cross-section in the direction of flow of coolant; and the number of ribs in the first group is greater than the number of ribs in the second group.

In an arrangement, at least one of the groups of ribs may be configured such that the cross-sectional area of the space between two adjacent ribs, transverse to the direction of flow of the coolant, is at least 6 mm2, optionally at least 8 mm2.

In an arrangement, at least one of the groups of ribs may be configured such that the maximum separation between adjacent ribs less than 20 mm, optionally less than 15 mm, optionally less than 10 mm.

In an arrangement, the component may comprise at least one further group of ribs. The groups of ribs may be arranged successively in the direction of the flow coolant such that, for two adjacent groups of ribs, ribs in one group are aligned with the spaces between the ribs of the other group.

In an arrangement, the group of ribs that is furthest downstream in the direction of flow of coolant extends to the end of the coolant channel in the component.

In an arrangement, the ribs in the group of ribs furthest downstream in the direction of flow of coolant may have a length in the direction of flow of coolant that is less than 20 mm, optionally less than 10 mm.

In an arrangement, the component may be an aerofoil blade or vane comprising an aerofoil leading edge, an aerofoil trailing edge and an aerofoil suction side.

The first and second walls may be provided on the aerofoil suction side and define a coolant channel to cool the aerofoil suction side of the component.

In an arrangement, the distance from the crown of the aerofoil to the midpoint between the first and second group of ribs may be less than 8% of the suction side length of the aerofoil from the crown to the aerofoil trailing edge, optionally less than 5% of the suction side length.

In an arrangement, in the region of the first and second groups of ribs, the coolant flow may be in a direction from the aerofoil leading edge to the aerofoil trailing edge.

In an arrangement, in the region of the first and second groups of ribs, the coolant flow may be in a direction from the aerofoil trailing edge to the aerofoil leading edge.

In an arrangement, there is provided a gas turbine engine for an aircraft comprising: an engine core comprising a turbine, a compressor, and a core shaft connecting the turbine to the compressor; a fan located upstream of the engine core, the fan comprising a plurality of fan blades; and a gearbox that receives an input from the core shaft and outputs drive to the fan so as to drive the fan at a lower rotational speed than the core shaft; and at least one component as discussed above.

In an arrangement, the turbine may be a first turbine, the compressor may be a first compressor, and the core shaft may be a first core shaft; the engine core may further comprise a second turbine, a second compressor, and a second core shaft connecting the second turbine to the second compressor; and the second turbine, second compressor, and second core shaft may be arranged to rotate at a higher rotational speed than the first core shaft.

In an arrangement, there is provided a ceramic core for use in investment casting of a component as discussed above, wherein the ceramic core is configured to define the shape of the coolant channel within the component during formation of the component and then be removed, leaving a space that is the shape of the coolant channel.

As noted elsewhere herein, the present disclosure may relate to a gas turbine engine. Such a gas turbine engine may comprise an engine core comprising a turbine, a combustor, a compressor, and a core shaft connecting the turbine to the compressor. Such a gas turbine engine may comprise a fan (having fan blades) located upstream of the engine core.

Arrangements of the present disclosure may be particularly, although not exclusively, beneficial for fans that are driven via a gearbox. Accordingly, the gas turbine engine may comprise a gearbox that receives an input from the core shaft and outputs drive to the fan so as to drive the fan at a lower rotational speed than the core shaft. The input to the gearbox may be directly from the core shaft, or indirectly from the core shaft, for example via a spur shaft and/or gear. The core shaft may rigidly connect the turbine and the compressor, such that the turbine and compressor rotate at the same speed (with the fan rotating at a lower speed).

The gas turbine engine as described and/or claimed herein may have any suitable general architecture. For example, the gas turbine engine may have any desired number of shafts that connect turbines and compressors, for example one, two or three shafts. Purely by way of example, the turbine connected to the core shaft may be a first turbine, the compressor connected to the core shaft may be a first compressor, and the core shaft may be a first core shaft. The engine core may further comprise a second turbine, a second compressor, and a second core shaft connecting the second turbine to the second compressor. The second turbine, second compressor, and second core shaft may be arranged to rotate at a higher rotational speed than the first core shaft.

In such an arrangement, the second compressor may be positioned axially downstream of the first compressor. The second compressor may be arranged to receive (for example directly receive, for example via a generally annular duct) flow from the first compressor.

The gearbox may be arranged to be driven by the core shaft that is configured to rotate (for example in use) at the lowest rotational speed (for example the first core shaft in the example above). For example, the gearbox may be arranged to be driven only by the core shaft that is configured to rotate (for example in use) at the lowest rotational speed (for example only be the first core shaft, and not the second core shaft, in the example above). Alternatively, the gearbox may be arranged to be driven by any one or more shafts, for example the first and/or second shafts in the example above.

In any gas turbine engine as described and/or claimed herein, a combustor may be provided axially downstream of the fan and compressor(s). For example, the combustor may be directly downstream of (for example at the exit of) the second compressor, where a second compressor is provided. By way of further example, the flow at the exit to the combustor may be provided to the inlet of the second turbine, where a second turbine is provided. The combustor may be provided upstream of the turbine(s).

The or each compressor (for example the first compressor and second compressor as described above) may comprise any number of stages, for example multiple stages. Each stage may comprise a row of rotor blades and a row of stator vanes, which may be variable stator vanes (in that their angle of incidence may be variable). The row of rotor blades and the row of stator vanes may be axially offset from each other.

The or each turbine (for example the first turbine and second turbine as described above) may comprise any number of stages, for example multiple stages. Each stage may comprise a row of rotor blades and a row of stator vanes. The row of rotor blades and the row of stator vanes may be axially offset from each other.

Each fan blade may be defined as having a radial span extending from a root (or hub) at a radially inner gas-washed location, or 0% span position, to a tip at a 100% span position. The ratio of the radius of the fan blade at the hub to the radius of the fan blade at the tip may be less than (or on the order of) any of: 0.4, 0.39, 0.38 0.37, 0.36, 0.35, 0.34, 0.33, 0.32, 0.31, 0.3, 0.29, 0.28, 0.27, 0.26, or 0.25. The ratio of the radius of the fan blade at the hub to the radius of the fan blade at the tip may be in an inclusive range bounded by any two of the values in the previous sentence (i.e. the values may form upper or lower bounds). These ratios may commonly be referred to as the hub-to-tip ratio. The radius at the hub and the radius at the tip may both be measured at the leading edge (or axially forwardmost) part of the blade. The hub-to-tip ratio refers, of course, to the gas-washed portion of the fan blade, i.e. the portion radially outside any platform.

The radius of the fan may be measured between the engine centreline and the tip of a fan blade at its leading edge. The fan diameter (which may simply be twice the radius of the fan) may be greater than (or on the order of) any of: 250 cm (around 100 inches), 260 cm, 270 cm (around 105 inches), 280 cm (around 110 inches), 290 cm (around 115 inches), 300 cm (around 120 inches), 310 cm, 320 cm (around 125 inches), 330 cm (around 130 inches), 340 cm (around 135 inches), 350 cm, 360 cm (around 140 inches), 370 cm (around 145 inches), 380 (around 150 inches) cm or 390 cm (around 155 inches). The fan diameter may be in an inclusive range bounded by any two of the values in the previous sentence (i.e. the values may form upper or lower bounds).

The rotational speed of the fan may vary in use. Generally, the rotational speed is lower for fans with a higher diameter. Purely by way of non-limitative example, the rotational speed of the fan at cruise conditions may be less than 2500 rpm, for example less than 2300 rpm. Purely by way of further non-limitative example, the rotational speed of the fan at cruise conditions for an engine having a fan diameter in the range of from 250 cm to 300 cm (for example 250 cm to 280 cm) may be in the range of from 1700 rpm to 2500 rpm, for example in the range of from 1800 rpm to 2300 rpm, for example in the range of from 1900 rpm to 2100 rpm. Purely by way of further non-limitative example, the rotational speed of the fan at cruise conditions for an engine having a fan diameter in the range of from 320 cm to 380 cm may be in the range of from 1200 rpm to 2000 rpm, for example in the range of from 1300 rpm to 1800 rpm, for example in the range of from 1400 rpm to 1600 rpm.

In use of the gas turbine engine, the fan (with associated fan blades) rotates about a rotational axis. This rotation results in the tip of the fan blade moving with a velocity Uₜᵢₚ. The work done by the fan blades 13 on the flow results in an enthalpy rise dH of the flow. A fan tip loading may be defined as dH/Uₜᵢₚ², where dH is the enthalpy rise (for example the 1-D average enthalpy rise) across the fan and Uₜᵢₚ is the (translational) velocity of the fan tip, for example at the leading edge of the tip (which may be defined as fan tip radius at leading edge multiplied by angular speed). The fan tip loading at cruise conditions may be greater than (or on the order of) any of: 0.3, 0.31, 0.32, 0.33, 0.34, 0.35, 0.36, 0.37, 0.38, 0.39 or 0.4 (all units in this paragraph being Jkg⁻¹K⁻¹/(ms⁻¹)²). The fan tip loading may be in an inclusive range bounded by any two of the values in the previous sentence (i.e. the values may form upper or lower bounds).

Gas turbine engines in accordance with the present disclosure may have any desired bypass ratio, where the bypass ratio is defined as the ratio of the mass flow rate of the flow through the bypass duct to the mass flow rate of the flow through the core at cruise conditions. In some arrangements the bypass ratio may be greater than (or on the order of) any of the following: 10, 10.5, 11, 11.5, 12, 12.5, 13, 13.5, 14, 14.5, 15, 15.5, 16, 16.5, or 17. The bypass ratio may be in an inclusive range bounded by any two of the values in the previous sentence (i.e. the values may form upper or lower bounds). The bypass duct may be substantially annular. The bypass duct may be radially outside the core engine. The radially outer surface of the bypass duct may be defined by a nacelle and/or a fan case.

The overall pressure ratio of a gas turbine engine as described and/or claimed herein may be defined as the ratio of the stagnation pressure upstream of the fan to the stagnation pressure at the exit of the highest pressure compressor (before entry into the combustor). By way of non-limitative example, the overall pressure ratio of a gas turbine engine as described and/or claimed herein at cruise may be greater than (or on the order of) any of the following: 35, 40, 45, 50, 55, 60, 65, 70, 75. The overall pressure ratio may be in an inclusive range bounded by any two of the values in the previous sentence (i.e. the values may form upper or lower bounds).

Specific thrust of an engine may be defined as the net thrust of the engine divided by the total mass flow through the engine. At cruise conditions, the specific thrust of an engine described and/or claimed herein may be less than (or on the order of) any of the following: 110 Nkg⁻¹ s, 105 Nkg⁻¹ s, 100 Nkg⁻¹ s, 95 Nkg⁻¹ s, 90 Nkg⁻¹ s, 85 Nkg⁻¹ s or 80 Nkg⁻¹ s. The specific thrust may be in an inclusive range bounded by any two of the values in the previous sentence (i.e. the values may form upper or lower bounds). Such engines may be particularly efficient in comparison with conventional gas turbine engines.

A gas turbine engine as described and/or claimed herein may have any desired maximum thrust. Purely by way of non-limitative example, a gas turbine as described and/or claimed herein may be capable of producing a maximum thrust of at least (or on the order of) any of the following: 160 kN, 170 kN, 180 kN, 190 kN, 200 kN, 250 kN, 300 kN, 350 kN, 400 kN, 450 kN, 500 kN, or 550 kN. The maximum thrust may be in an inclusive range bounded by any two of the values in the previous sentence (i.e. the values may form upper or lower bounds). The thrust referred to above may be the maximum net thrust at standard atmospheric conditions at sea level plus 15 deg C. (ambient pressure 101.3 kPa, temperature 30 deg C.), with the engine static.

In use, the temperature of the flow at the entry to the high pressure turbine may be particularly high. This temperature, which may be referred to as TET, may be measured at the exit to the combustor, for example immediately upstream of the first turbine vane, which itself may be referred to as a nozzle guide vane. At cruise, the TET may be at least (or on the order of) any of the following: 1400K, 1450K, 1500K, 1550K, 1600K or 1650K. The TET at cruise may be in an inclusive range bounded by any two of the values in the previous sentence (i.e. the values may form upper or lower bounds). The maximum TET in use of the engine may be, for example, at least (or on the order of) any of the following: 1700K, 1750K, 1800K, 1850K, 1900K, 1950K or 2000K. The maximum TET may be in an inclusive range bounded by any two of the values in the previous sentence (i.e. the values may form upper or lower bounds). The maximum TET may occur, for example, at a high thrust condition, for example at a maximum take-off (MTO) condition.

A fan blade and/or aerofoil portion of a fan blade described and/or claimed herein may be manufactured from any suitable material or combination of materials. For example at least a part of the fan blade and/or aerofoil may be manufactured at least in part from a composite, for example a metal matrix composite and/or an organic matrix composite, such as carbon fibre. By way of further example at least a part of the fan blade and/or aerofoil may be manufactured at least in part from a metal, such as a titanium based metal or an aluminium based material (such as an aluminium-lithium alloy) or a steel based material. The fan blade may comprise at least two regions manufactured using different materials. For example, the fan blade may have a protective leading edge, which may be manufactured using a material that is better able to resist impact (for example from birds, ice or other material) than the rest of the blade. Such a leading edge may, for example, be manufactured using titanium or a titanium-based alloy. Thus, purely by way of example, the fan blade may have a carbon-fibre or aluminium based body (such as an aluminium lithium alloy) with a titanium leading edge.

A fan as described and/or claimed herein may comprise a central portion, from which the fan blades may extend, for example in a radial direction. The fan blades may be attached to the central portion in any desired manner. For example, each fan blade may comprise a fixture which may engage a corresponding slot in the hub (or disc). Purely by way of example, such a fixture may be in the form of a dovetail that may slot into and/or engage a corresponding slot in the hub/disc in order to fix the fan blade to the hub/disc. By way of further example, the fan blades may be formed integrally with a central portion. Such an arrangement may be referred to as a blisk or a bling. Any suitable method may be used to manufacture such a blisk or bling. For example, at least a part of the fan blades may be machined from a block and/or at least part of the fan blades may be attached to the hub/disc by welding, such as linear friction welding.

The gas turbine engines described and/or claimed herein may or may not be provided with a variable area nozzle (VAN). Such a variable area nozzle may allow the exit area of the bypass duct to be varied in use. The general principles of the present disclosure may apply to engines with or without a VAN.

The fan of a gas turbine as described and/or claimed herein may have any desired number of fan blades, for example 16, 18, 20, or 22 fan blades.

As used herein, cruise conditions may mean cruise conditions of an aircraft to which the gas turbine engine is attached. Such cruise conditions may be conventionally defined as the conditions at mid-cruise, for example the conditions experienced by the aircraft and/or engine at the midpoint (in terms of time and/or distance) between top of climb and start of decent.

Purely by way of example, the forward speed at the cruise condition may be any point in the range of from Mach 0.7 to 0.9, for example 0.75 to 0.85, for example 0.76 to 0.84, for example 0.77 to 0.83, for example 0.78 to 0.82, for example 0.79 to 0.81, for example on the order of Mach 0.8, on the order of Mach 0.85 or in the range of from 0.8 to 0.85. Any single speed within these ranges may be the cruise condition. For some aircraft, the cruise conditions may be outside these ranges, for example below Mach 0.7 or above Mach 0.9.

Purely by way of example, the cruise conditions may correspond to standard atmospheric conditions at an altitude that is in the range of from 10000 m to 15000 m, for example in the range of from 10000 m to 12000 m, for example in the range of from 10400 m to 11600 m (around 38000 ft), for example in the range of from 10500 m to 11500 m, for example in the range of from 10600 m to 11400 m, for example in the range of from 10700 m (around 35000 ft) to 11300 m, for example in the range of from 10800 m to 11200 m, for example in the range of from 10900 m to 11100 m, for example on the order of 11000 m. The cruise conditions may correspond to standard atmospheric conditions at any given altitude in these ranges.

Purely by way of example, the cruise conditions may correspond to: a forward Mach number of 0.8; a pressure of 23000 Pa; and a temperature of −55 deg C.

As used anywhere herein, “cruise” or “cruise conditions” may mean the aerodynamic design point. Such an aerodynamic design point (or ADP) may correspond to the conditions (comprising, for example, one or more of the Mach Number, environmental conditions and thrust requirement) for which the fan is designed to operate. This may mean, for example, the conditions at which the fan (or gas turbine engine) is designed to have optimum efficiency.

In use, a gas turbine engine described and/or claimed herein may operate at the cruise conditions defined elsewhere herein. Such cruise conditions may be determined by the cruise conditions (for example the mid-cruise conditions) of an aircraft to which at least one (for example 2 or 4) gas turbine engine may be mounted in order to provide propulsive thrust.

The skilled person will appreciate that except where mutually exclusive, a feature or parameter described in relation to any one of the above aspects may be applied to any other aspect. Furthermore, except where mutually exclusive, any feature or parameter described herein may be applied to any aspect and/or combined with any other feature or parameter described herein.

### DESCRIPTION OF THE DRAWINGS

Embodiments will now be described by way of example only, with reference to the Figures, in which:

FIG. 1 is a sectional side view of a gas turbine engine;

FIG. 2 is a close up sectional side view of an upstream portion of a gas turbine engine;

FIG. 3 is a partially cut-away view of a gearbox for a gas turbine engine;

FIG. 4 schematically depicts, in cross-section, a component to which the present disclosure may apply;

FIG. 5 schematically depicts, in cross-section, a ceramic core for use in the manufacture of the aerofoil component depicted in FIG. 4; and

FIGS. 6, 7, 8 and 9 schematically depict possible arrangements of ribs according to the present disclosure.

### DETAILED DESCRIPTION

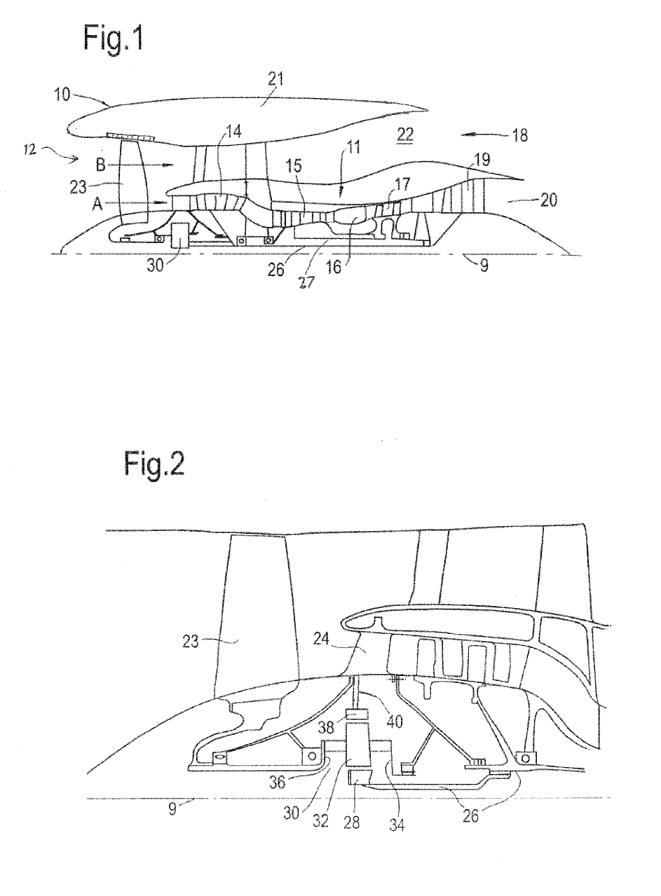

FIG. 1 illustrates a gas turbine engine 10 having a principal rotational axis 9. The engine 10 comprises an air intake 12 and a propulsive fan 23 that generates two airflows: a core airflow A and a bypass airflow B. The gas turbine engine 10 comprises a core 11 that receives the core airflow A. The engine core 11 comprises, in axial flow series, a low pressure compressor 14, a high-pressure compressor 15, combustion equipment 16, a high-pressure turbine 17, a low pressure turbine 19 and a core exhaust nozzle 20. A nacelle 21 surrounds the gas turbine engine 10 and defines a bypass duct 22 and a bypass exhaust nozzle 18. The bypass airflow B flows through the bypass duct 22. The fan 23 is attached to and driven by the low pressure turbine 19 via a shaft 26 and an epicyclic gearbox 30.

In use, the core airflow A is accelerated and compressed by the low pressure compressor 14 and directed into the high pressure compressor 15 where further compression takes place. The compressed air exhausted from the high pressure compressor 15 is directed into the combustion equipment 16 where it is mixed with fuel and the mixture is combusted. The resultant hot combustion products then expand through, and thereby drive, the high pressure and low pressure turbines 17, 19 before being exhausted through the nozzle 20 to provide some propulsive thrust. The high pressure turbine 17 drives the high pressure compressor 15 by a suitable interconnecting shaft 27. The fan 23 generally provides the majority of the propulsive thrust. The epicyclic gearbox 30 is a reduction gearbox.

An exemplary arrangement for a geared fan gas turbine engine 10 is shown in FIG. 2. The low pressure turbine 19 (see FIG. 1) drives the shaft 26, which is coupled to a sun wheel, or sun gear, 28 of the epicyclic gear arrangement 30. Radially outwardly of the sun gear 28 and intermeshing therewith is a plurality of planet gears 32 that are coupled together by a planet carrier 34. The planet carrier 34 constrains the planet gears 32 to precess around the sun gear 28 in synchronicity whilst enabling each planet gear 32 to rotate about its own axis. The planet carrier 34 is coupled via linkages 36 to the fan 23 in order to drive its rotation about the engine axis 9. Radially outwardly of the planet gears 32 and intermeshing therewith is an annulus or ring gear 38 that is coupled, via linkages 40, to a stationary supporting structure 24.

Note that the terms “low pressure turbine” and “low pressure compressor” as used herein may be taken to mean the lowest pressure turbine stages and lowest pressure compressor stages (i.e. not including the fan 23) respectively and/or the turbine and compressor stages that are connected together by the interconnecting shaft 26 with the lowest rotational speed in the engine (i.e. not including the gearbox output shaft that drives the fan 23). In some literature, the “low pressure turbine” and “low pressure compressor” referred to herein may alternatively be known as the “intermediate pressure turbine” and “intermediate pressure compressor”. Where such alternative nomenclature is used, the fan 23 may be referred to as a first, or lowest pressure, compression stage.

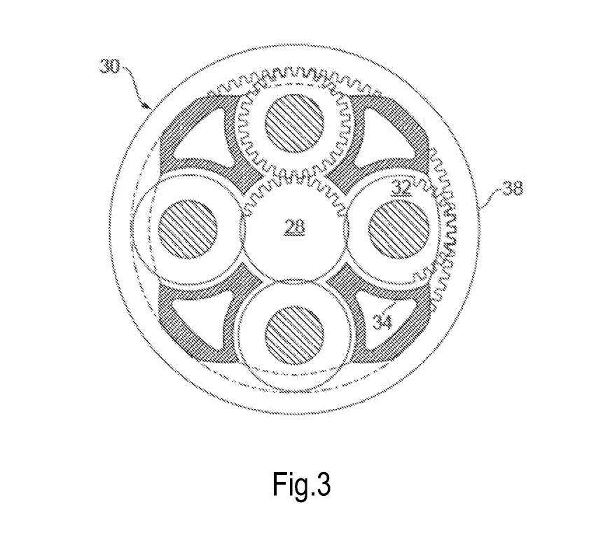

The epicyclic gearbox 30 is shown by way of example in greater detail in FIG. 3. Each of the sun gear 28, planet gears 32 and ring gear 38 comprise teeth about their periphery to intermesh with the other gears. However, for clarity only exemplary portions of the teeth are illustrated in FIG. 3. There are four planet gears 32 illustrated, although it will be apparent to the skilled reader that more or fewer planet gears 32 may be provided within the scope of the present disclosure. Practical applications of a planetary epicyclic gearbox 30 generally comprise at least three planet gears 32.

The epicyclic gearbox 30 illustrated by way of example in FIGS. 2 and 3 is of the planetary type, in that the planet carrier 34 is coupled to an output shaft via linkages 36, with the ring gear 38 fixed. However, any other suitable type of epicyclic gearbox 30 may be used. By way of further example, the epicyclic gearbox 30 may be a star arrangement, in which the planet carrier 34 is held fixed, with the ring (or annulus) gear 38 allowed to rotate. In such an arrangement the fan 23 is driven by the ring gear 38. By way of further alternative example, the gearbox 30 may be a differential gearbox in which the ring gear 38 and the planet carrier 34 are both allowed to rotate.

It will be appreciated that the arrangement shown in FIGS. 2 and 3 is by way of example only, and various alternatives are within the scope of the present disclosure. Purely by way of example, any suitable arrangement may be used for locating the gearbox 30 in the engine 10 and/or for connecting the gearbox 30 to the engine 10. By way of further example, the connections (such as the linkages 36, 40 in the FIG. 2 example) between the gearbox 30 and other parts of the engine 10 (such as the input shaft 26, the output shaft and the fixed structure 24) may have any desired degree of stiffness or flexibility. By way of further example, any suitable arrangement of the bearings between rotating and stationary parts of the engine (for example between the input and output shafts from the gearbox and the fixed structures, such as the gearbox casing) may be used, and the disclosure is not limited to the exemplary arrangement of FIG. 2. For example, where the gearbox 30 has a star arrangement (described above), the skilled person would readily understand that the arrangement of output and support linkages and bearing locations would typically be different to that shown by way of example in FIG. 2.

Accordingly, the present disclosure extends to a gas turbine engine having any arrangement of gearbox styles (for example star or planetary), support structures, input and output shaft arrangement, and bearing locations.

Optionally, the gearbox may drive additional and/or alternative components (e.g. the intermediate pressure compressor and/or a booster compressor).

Other gas turbine engines to which the present disclosure may be applied may have alternative configurations. For example, such engines may have an alternative number of compressors and/or turbines and/or an alternative number of interconnecting shafts. By way of further example, the gas turbine engine shown in FIG. 1 has a split flow nozzle 20, 22 meaning that the flow through the bypass duct 22 has its own nozzle that is separate to and radially outside the core engine nozzle 20. However, this is not limiting, and any aspect of the present disclosure may also apply to engines in which the flow through the bypass duct 22 and the flow through the core 11 are mixed, or combined, before (or upstream of) a single nozzle, which may be referred to as a mixed flow nozzle. One or both nozzles (whether mixed or split flow) may have a fixed or variable area. Whilst the described example relates to a turbofan engine, the disclosure may apply, for example, to any type of gas turbine engine, such as an open rotor (in which the fan stage is not surrounded by a nacelle) or turboprop engine, for example. In some arrangements, the gas turbine engine 10 may not comprise a gearbox 30.

The geometry of the gas turbine engine 10, and components thereof, is defined by a conventional axis system, comprising an axial direction (which is aligned with the rotational axis 9), a radial direction (in the bottom-to-top direction in FIG. 1), and a circumferential direction (perpendicular to the page in the FIG. 1 view). The axial, radial and circumferential directions are mutually perpendicular.

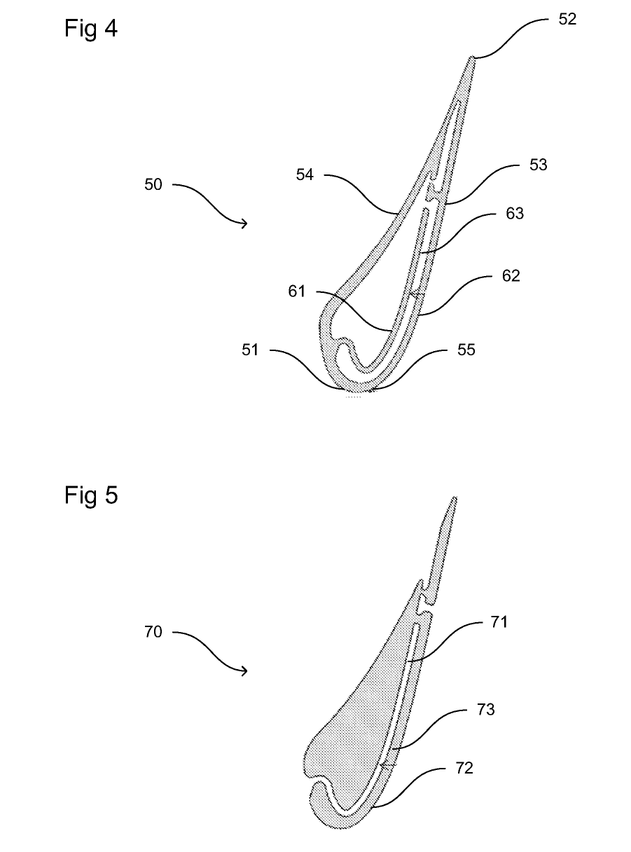

FIG. 4 schematically depicts, in cross-section, a component to which the present disclosure may apply, in particular an aerofoil blade that may be incorporated within a turbine. Such an aerofoil component 50 has a leading edge 51, trailing edge 52, suction side 53 and pressure side 54 as generally indicated in FIG. 4.

As shown, the suction side 53 of the aerofoil 50 is formed from an inner wall 61 and an outer wall 62 with a space 63 provided between the inner wall 61 and outer wall 62. The space 63 is configured to receive a flow of coolant in order to cool the suction side 53 of the aerofoil 50. One or more apertures, not shown in FIG. 4, may connect the space 63 to the exterior surface of the aerofoil 50. In such an arrangement, coolant may be provided to the root of the aerofoil, flow through a supply channel in the aerofoil to the coolant channel, flow through the coolant channel provided by the space 63 and out through the apertures. In some cases, the apertures may be configured such that coolant flows over the surface of the aerofoil 50.

In order to form the aerofoil 50, including the space 63 defining the coolant channel, an investment casting process may be used. In such a process, a ceramic core is formed having the shape of the internal cavities desired within the aerofoil component 50, including the space 63 between the inner wall 61 and the outer wall 62. The component, such as aerofoil 50, is subsequently formed around the core, for example, by casting. Finally, the core is removed, for example leached with alkaline solution to leave the component with cavities of the desired shapes.

FIG. 5 schematically depicts, in cross-section, a ceramic core 70 for use in the manufacture of the aerofoil component depicted in FIG. 4. As shown, the ceramic core 70 includes a cavity 71 that corresponds to the desired shape of the internal wall 61 of the aerofoil component 50. The outer surface 72 of the ceramic core defines the inner surface of the outer wall 62 of the aerofoil component 50. A section 73 of the core 70 corresponds to the shape of the space 63 between the inner wall 61 and the outer wall 62 of the aerofoil component 50.

Within the aerofoil component 50, elongate are be provided between the inner wall 61 and the outer wall 62. The ribs may mechanically attach the inner wall 61 and outer wall 62 together, improving the structural strength of the aerofoil component 50. Alternatively or additionally, the ribs may function to subdivide the space 63 between the inner wall 61 and the outer wall 62, namely the coolant channel, and/or guide the direction of the flow of coolant within the coolant channel.

However, the provision of ribs traversing the space 63 between the inner wall 61 and the outer wall 62 of the aerofoil component 50 corresponds to the provision of voids within the section 73 of the core 70 that defines the space 63 in the finished component. These holes may weaken the core 70. This may result in breakage of parts of the core 70 during the formation of the aerofoil component 50 around the core 70 and/or relative movement of one part of the core 70 relative to another part of the core 70 during formation of the aerofoil component 50 around the core 70, resulting in erroneous formation of the aerofoil component 50.

The selection of the size of the ribs may therefore be a compromise between a benefit of increasing the size of the ribs for the structural strength of the aerofoil component 50 and/or controlling the direction of coolant flow within the space 63 between the inner wall 61 and the outer wall 62 and a disadvantage of correspondingly reducing the strength of the ceramic core 70 by increasing the size of the holes within it.

An additional factor that may affect the selection of the size of the ribs results from the process of forming the ceramic core. The ceramic core may be manufactured using a ceramic injection moulding process (CIM). A ceramic material, for example silica, is suspended in an organic, polymeric binder to create a feedstock. This feedstock is then injected into a die cavity of the required side and shape to create a “green” component, comprised of the ceramic and binder component. The binder is subsequently thermally or chemically removed and the ceramic consolidated by sintering/firing at elevated temperatures; this gives the final ceramic core.

The core is usually supported during the firing process by placing it within a ceramic receptacle and surrounding it with an inert firing power. This may have the advantage of promoting controlled binder removal by wicking during the early stages of firing. However, in the case of a ceramic core such as that depicted in FIG. 5, it can be difficult to remove the firing media from the cavity 71 that corresponds to the inner wall 61 to be formed within the aerofoil component 50. It may also be difficult to inspect the cavity 71 in order to ensure that correct formation of the core 70 has taken place and that the firing media has been removed. As discussed above, the ribs to be formed between the inner wall 61 and the outer wall 62 of the aerofoil component 50 correspond to holes within the section 73 of the ceramic core 70 that corresponds to the space 63 to be provided between the inner wall 61 and outer wall 62 of the aerofoil component 50. These holes may provide access to the cavity 71 for firing media removal and/or inspection.

The present disclosure provides arrangements of ribs for use in components such as an aerofoil 50 that may enable improvements in the product incorporating the ribs and/or the manufacturing process. It should be appreciated that, although this disclosure is provided in the context of the formation of an aerofoil blade or vane, in general the arrangement is applicable to other components within a gas turbine engine in which a coolant channel is provided between first and second walls and having ribs extending between the first and second walls. Such other components may include the combustion liner, turbine rotor liner, or afterburner systems.

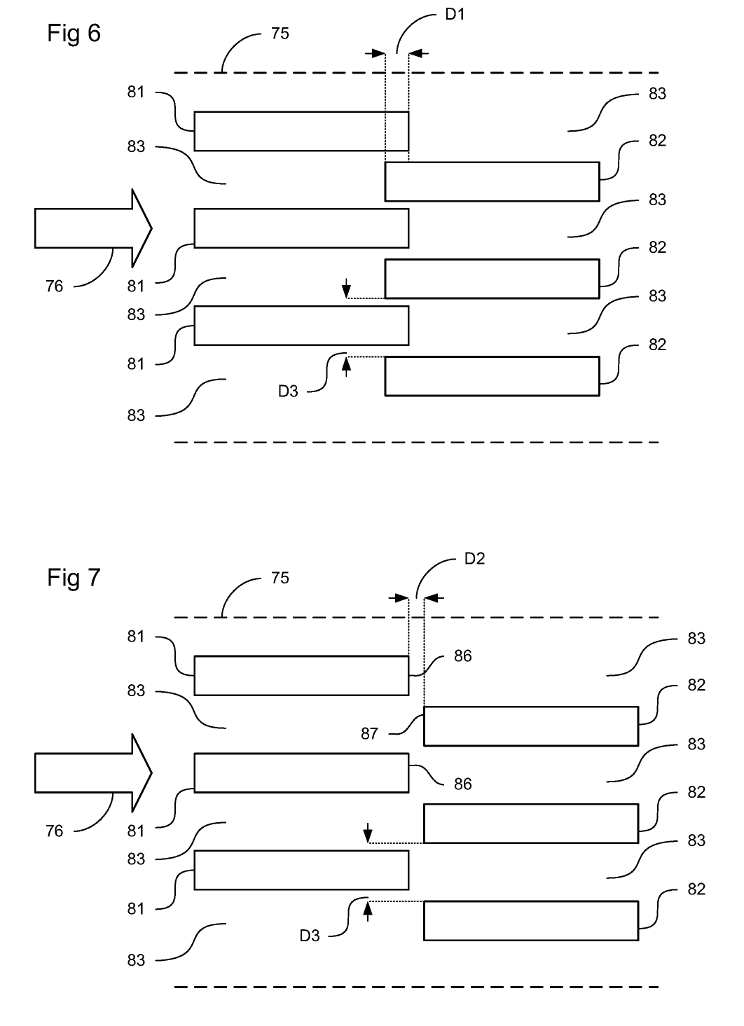

FIGS. 6, 7, 8 and 9 schematically depict possible arrangements of ribs. It will be appreciated that in reality the ribs may have rounded corners in order to reduce stress concentrations. As shown, the ribs 81, 82 may generally be elongate in nature. The ribs provided within a space 63 between first and second walls 61, 62 may subdivide a coolant channel 75 that is defined by the first and second walls 61, 62. In particular, the coolant channel 75 and ribs may be configured such that coolant flows within spaces 83 between two adjacent ribs 81, 82 in a direction 76 that is aligned with the elongate length of the ribs 81, 82. In local regions, the direction of the flow of coolant 76 within the spaces 83 may be parallel to the elongate length of the ribs 81, 82.

In an arrangement, the configuration includes a first group of ribs 81 and a second group of ribs 82 that may be arranged downstream of the first group of ribs 81 in the direction of the flow of coolant 76. The ribs 81, 82 of each group are arranged in an interlaced manner such that they are aligned with the spaces 83 between the ribs 81, 82 of the other groups. Accordingly, for example as shown in FIG. 6, the ribs 81 of the first group are aligned with the spaces 83 between the ribs 82 of the second group. The ribs 82 of the second group are aligned with the spaces 83 between the ribs 81 of the first group.

It should be appreciated that, in such an arrangement, an outermost rib of a group of ribs 81, 82 may be considered to be aligned with a space 83 between the ribs 81, 82 of an adjacent group even where the opposing space 83 for that particular rib is only bounded on one side by a rib of the other group.

As shown in FIG. 6, at least one rib 82 in the second group of ribs 82 may extend into the space 83 between two ribs 81 in the first group of ribs 81. In such an arrangement, the length D1 of the part 85 of the rib 82 of the second group of ribs that extends into the space 83 between two ribs 81 of the first group of ribs may be less than 5 mm and, optionally, may be less than 3 mm.

In an alternative arrangement, as shown in FIG. 7, at least one rib 82 in the second group of ribs 82 may be arranged such that no part of the rib 82 extends into the space 83 between the two ribs 81 in the first group of ribs 81 with which it is aligned. In an arrangement, the separation D2 between the end 87 of the rib 82 in the second group of ribs 82 and the ends 86 of the ribs 81 in the first group of ribs 81 may be less than 5 mm and, optionally, less than 3 mm. In an arrangement, the separation D2 between the ends 86, 87 of the ribs 81, 82 may be zero such that the ends 86, 87 are aligned.

It should be appreciated that a combination of the arrangements shown in FIGS. 6 and 7 may be used, in which some ribs 81, 82 of one of the groups of ribs 81, 82 extend into the space 83 between ribs 81, 82 of the adjacent group of ribs 81, 82 and some do not.

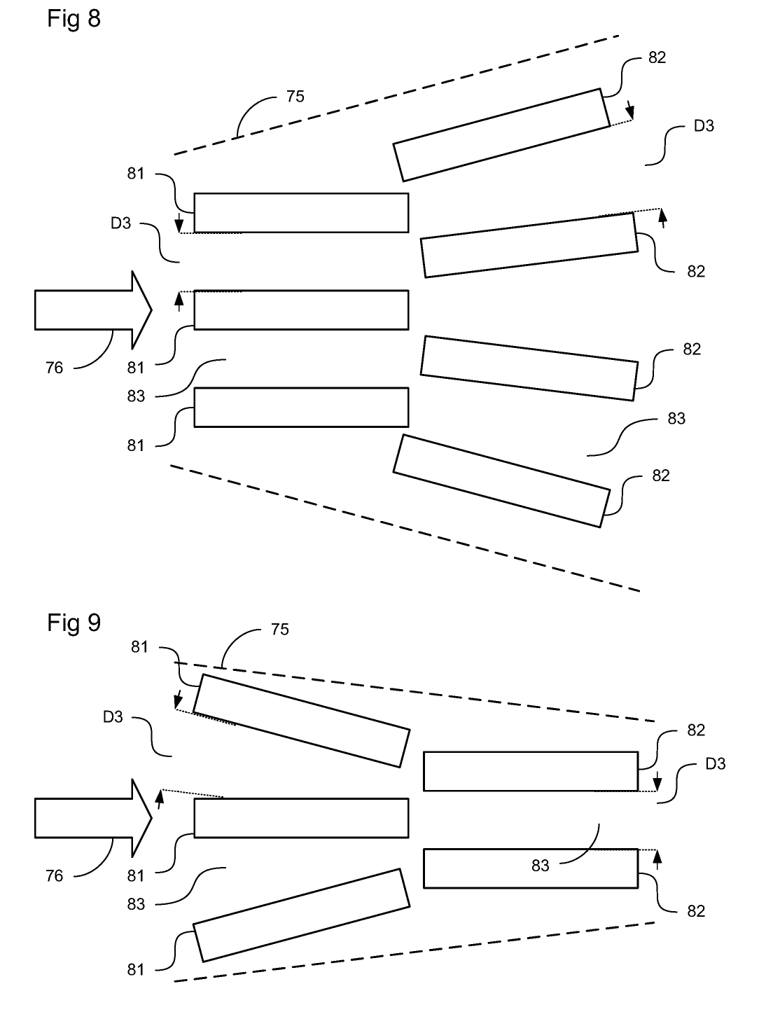

In an arrangement, as schematically depicted in FIG. 8, the coolant channel 75 may diverge, namely get broader in the downstream direction as defined by the direction of flow of coolant 76. In such an arrangement, the number of ribs 82 within the second group of ribs 82 (downstream from the first group) may be greater than the number of ribs 81 in the first group of ribs. Similarly, in an arrangement as shown in FIG. 9, the coolant channel 75 may converge in the downstream direction as defined by the direction of flow of coolant 76. In such an arrangement, the number of ribs 81 in the first group of ribs 81 (upstream from the second group) may be greater than the number of ribs 82 in the second group of ribs 82.

By providing appropriate numbers of ribs 81, 82 in the each of the first and groups of ribs, 81, 82, the separation D3 between adjacent ribs 81, 82 within each group of ribs 81, 82 may be controlled, for example to meet design criteria such as those discussed below. In an arrangement, the transition between the first and second groups of ribs 81, 82 may be positioned within the coolant channel 75 at a location where the change in width of the coolant channel 75 results in a change in the desired number of ribs 81, 82 to meet the design criteria discussed below.

The separation between adjacent ribs 81, 82 corresponds to a section of the ceramic core. In an arrangement, the cross-sectional area of the space between two adjacent ribs 81, 82 transverse to the direction of flow of the coolant 76, may be at least 6 mm², optionally at least 8 mm². This corresponds to ensuring that the minimum cross-sectional area of a section of the ceramic core used in the manufacture of the component is greater than 6 mm² and optionally greater than at least 8 mm². This may ensure that such a section of the ceramic core has at least a minimum strength and may reduce the likelihood of breakage and/or deflection of a section of the core during the formation of the component 50 around the core 70.

In an arrangement, the ribs 81, 82 may be configured such that the maximum separation D3 between adjacent ribs 81, 82 in a direction perpendicular to the direction the flow of coolant 76 is less than 20 mm, optionally less than 15 mm, optionally less than 10 mm. This may assist in ensuring that the mechanical strength of the component 50 is sufficient and may provide sufficient access to the cavity 71 within the core to provide access for removal of firing media and inspection of the cavity 71.

Although the disclosure above has related to the provision of a component with two groups of ribs 81, 82 arranged successively in the direction of the flow of coolant 76, such that the second group of ribs 82 is downstream of the first group of ribs 81, in general a component may have further groups of ribs successively arranged in the direction of flow of coolant 76. In such an arrangement, each group of ribs may be arranged such that for two adjacent groups of ribs, ribs in one group are aligned with the spaces between the ribs of the other group in accordance with any of the arrangements discussed above in the context of the first and second group of ribs 81, 82.

In an arrangement, the group of ribs 81, 82 that is furthest downstream in the direction of flow of coolant may extend to the end of the coolant channel 75 within the component 50. In the case of an aerofoil blade 50, such as is shown in FIG. 4, this may be located at or near the aerofoil trailing edge 52. The group of ribs that is most downstream may be configured to have a length in the elongate direction of the ribs that is less than 20 mm, optionally less than 10 mm. Such an arrangement may avoid provision of a large area of unsupported core 70, which may result in manufacturing defects.

In the case of a component 50 so that is an aerofoil blade or vane, the arrangement of the ribs 81, 82 may be such that the transition between two groups of ribs 81, 82 is in the region of the so-called crown point 55 of the aerofoil. The crown point 55, or shoulder, is the position of the suction side 62 of the aerofoil 50 having the greatest circumferential extent away from the trailing edge.

In an arrangement, the centre of the transition between the first and second groups of ribs 81, 82, namely the midpoint between the ends 86, 87 of the ribs 81, 82 may be arranged at a location that is within 8% of the suction side length of the aerofoil, from the crown 55 to the aerofoil trailing edge 52, and optionally less than 5% of the suction side length. This may be beneficial because the region of the crown point 55 is particularly susceptible to mechanical failure due to the high surface curvature. In the region of the transition between the first and second group of ribs 81, 82 there may be the greatest structural support between the first and second walls 61, 62 provided by the ribs. Accordingly, locating the transition between the first and second groups of ribs 81, 82 in the region of the crown point 55 may reduce the likelihood of mechanical failure.

In the case of providing flows of coolant within an aerofoil blade or vane, a variety of arrangements of coolant flow have been considered, including arrangements in which the coolant generally flows from the leading edge 51 to the trailing edge 52 of the aerofoil 50 and so-called reverse-pass systems in which in at least some regions within an aerofoil 50, the coolant generally flows in a direction from the trailing edge 52 to the leading edge 51 of the aerofoil 50. The arrangements of ribs 81, 82 discussed herein may be used in either such coolant arrangement. Accordingly, in an arrangement, in the region of the first and second groups of ribs 81, 82, the coolant flow direction 76 may be in a direction from the aerofoil leading edge 51 to the aerofoil trailing edge 51. In an arrangement, in the region of the first and second groups of ribs 81, 82, the coolant flow direction may be in a direction from the aerofoil trailing edge 52 to the aerofoil leading edge 51.

It will be understood that the invention is not limited to the embodiments above-described and various modifications and improvements can be made without departing from the concepts described herein. Except where mutually exclusive, any of the features may be employed separately or in combination with any other features and the disclosure extends to and includes all combinations and sub-combinations of one or more features described herein.

1. An aerofoil blade or vane for a gas turbine engine, comprising an aerofoil leading edge, an aerofoil trailing edge an aerofoil suction side having a crown point:
first and second walls provided on the aerofoil suction side;
a coolant channel for cooling the aerofoil suction side defined by the space between the first and second walls; and
a plurality of ribs extending between the first and second walls, subdividing the coolant channel and configured such that the spaces between the ribs define the direction of flow of coolant through the coolant channel;
wherein the ribs are arranged in first and second groups; and
the second group of ribs is arranged downstream of the first group of ribs in the direction of the flow of coolant such that the ribs of the second group are aligned with the spaces between the ribs of the first group; wherein the distance from the crown point of the aerofoil to the midpoint between the first and second group of ribs is less than 8% of the suction side length of the aerofoil from the crown point to the aerofoil trailing edge.

2. A blade or vane according to claim 1, wherein a part of at least one rib in the second group of ribs extends into the space between two ribs in the first group with which it is aligned.

3. A blade or vane according to claim 2, wherein the length of the part of the at least one rib in the second group that extends into the space between two ribs in the first group is less than 5 mm.

4. A blade or vane according to claim 1, wherein at least one rib in the second group is configured such that no part of the rib extends into the space between the two ribs in the first group with which it is aligned.

5. A blade or vane according to claim 4, wherein the end of the at least one rib in the second group is separated from the ends of the two ribs in the first group by a distance in the direction of the flow of the coolant of less than 5 mm.

6. A blade or vane according to claim 1, wherein the coolant channel increases in cross-section in the direction of flow of coolant; and the number of ribs in the second group is greater than the number of ribs in the first group.

7. A blade or vane according to claim 1, wherein the coolant channel decreases in cross-section in the direction of flow of coolant; and the number of ribs in the first group is greater than the number of ribs in the second group.

8. A blade or vane according to claim 1, wherein at least one of the groups of ribs is configured such that the cross-sectional area of the space between two adjacent ribs, transverse to the direction of flow of the coolant, is at least 6 mm².

9. A blade or vane according to claim 1, wherein at least one of the groups of ribs is configured such that the maximum separation between adjacent ribs less than 20 mm.

10. A blade or vane according to claim 1, comprising at least one further group of ribs;
wherein the groups of ribs are arranged successively in the direction of the flow coolant such that, for two adjacent groups of ribs, ribs in one group are aligned with the spaces between the ribs of the other group.

11. A blade or vane according to claim 1, wherein the group of ribs that is furthest downstream in the direction of flow of coolant extends to the end of the coolant channel in the component.

12. A blade or vane according to claim 1, wherein the ribs in the group of ribs furthest downstream in the direction of flow of coolant have a length in the direction of flow of coolant that is less than 20 mm.

13. A blade or vane according to claim 1, wherein in the region of the first and second groups of ribs, the coolant flow is in a direction from the aerofoil leading edge to the aerofoil trailing edge.

14. A blade or vane according to claim 1, wherein in the region of the first and second groups of ribs, the coolant flow is in a direction from the aerofoil trailing edge to the aerofoil leading edge.

15. A gas turbine engine for an aircraft comprising:
an engine core comprising a turbine, a compressor, and a core shaft connecting the turbine to the compressor;
a fan located upstream of the engine core, the fan comprising a plurality of fan blades; and
a gearbox that receives an input from the core shaft and outputs drive to the fan so as to drive the fan at a lower rotational speed than the core shaft;
and at least one aerofoil blade or vane for a gas turbine engine, comprising an aerofoil leading edge, an aerofoil trailing edge an aerofoil suction side having a crown point:
first and second walls provided on the aerofoil suction side;
a coolant channel for cooling the aerofoil suction side defined by the space between the first and second walls; and
a plurality of ribs extending between the first and second walls, subdividing the coolant channel and configured such that the spaces between the ribs define the direction of flow of coolant through the coolant channel;
wherein the ribs are arranged in first and second groups; and
the second group of ribs is arranged downstream of the first group of ribs in the direction of the flow of coolant such that the ribs of the second group are aligned with the spaces between the ribs of the first group; wherein the distance from the crown point of the aerofoil to the midpoint between the first and second group of ribs is less than 8% of the suction side length of the aerofoil from the crown point to the aerofoil trailing edge.

16. A blade or vane according to claim 15, wherein the coolant channel increases in cross-section in the direction of flow of coolant; and the number of ribs in the second group is greater than the number of ribs in the first group.

17. A blade or vane according to claim 15, wherein the coolant channel decreases in cross-section in the direction of flow of coolant; and the number of ribs in the first group is greater than the number of ribs in the second group.

18. The gas turbine engine according to claim 15, wherein:
the turbine is a first turbine, the compressor is a first compressor, and the core shaft is a first core shaft;
the engine core further comprises a second turbine, a second compressor, and a second core shaft connecting the second turbine to the second compressor; and
the second turbine, second compressor, and second core shaft are arranged to rotate at a higher rotational speed than the first core shaft.

19. A ceramic core for use in investment casting of a aerofoil blade or vane, comprising an aerofoil leading edge, an aerofoil trailing edge an aerofoil suction side having a crown point:
first and second walls provided on the aerofoil suction side;
a coolant channel for cooling the aerofoil suction side defined by the space between the first and second walls; and
a plurality of ribs extending between the first and second walls, subdividing the coolant channel and configured such that the spaces between the ribs define the direction of flow of coolant through the coolant channel;
wherein the ribs are arranged in first and second groups; and
the second group of ribs is arranged downstream of the first group of ribs in the direction of the flow of coolant such that the ribs of the second group are aligned with the spaces between the ribs of the first group; wherein the distance from the crown point of the aerofoil to the midpoint between the first and second group of ribs is less than 8% of the suction side length of the aerofoil from the crown point to the aerofoil trailing edge;
wherein the ceramic core is configured to define the shape of the coolant channel within the component during formation of the component and then be removed, leaving a space that is the shape of the coolant channel.
